(19) United States
(12) Patent Application Publication
(10) Pub. No.: US 2020/0305124 A1
(43) Pub. Date: Sep. 24, 2020

(54) ENHANCED GAIN CONTROL FOR CO-LOCATED INTERFERENCE

(71) Applicant: QUALCOMM Incorporated, San Diego, CA (US)

(72) Inventors: Shi-Cong Yang, San Jose, CA (US); Louay Jalloul, San Jose, CA (US); Olaf Josef Hirsch, Sunnyvale, CA (US); Tianqi Wang, Sunnyvale, CA (US); Qinfang Sun, Cupertino, CA (US)

(21) Appl. No.: 16/359,863

(22) Filed: Mar. 20, 2019

(51) Int. Cl. H04W 72/00; H04W 72/08; H04W 72/04

(52) U.S. Cl. CPC H04W 72/005; H04W 72/082; H04W 84/12; H04W 72/0453; H04W 72/0446

(57) ABSTRACT

A system and method are disclosed that may allow for enhanced gain control for two radios. In an example method, a first radio may receive a wireless signal on a first frequency band, the wireless signal including at least a header and a payload. A first gain control operation may be performed based at least in part on information in the header of the wireless signal. A second radio may be determined to initiate a transmission on a second frequency coinciding with the first frequency band before reception of the wireless signal is completed, where the second radio is co-located with the first radio. A second gain control operation may be performed based at least in part on an expected interference associated with the transmission from the second radio, and one or more gain levels may be adjusted for reception of the wireless signal, based on the second gain control operation.

### TECHNICAL FIELD

The example implementations relate generally to wireless networks, and specifically to improving performance of co-located transceivers.

### BACKGROUND OF RELATED ART

A wireless local area network (WLAN) may be formed by one or more access points (APs) that provide a shared wireless communication medium for use by a number of client devices or stations (STAs). Each AP, which may correspond to a Basic Service Set (BSS), periodically broadcasts beacon frames to enable any STAs within wireless range of the AP to establish and/or maintain a communication link with the WLAN. In a typical WLAN, only one STA may use the wireless medium at any given time, and each STA may be associated with only one AP at a time.

### SUMMARY

Aspects of the present disclosure relate to methods an apparatus for enhanced gain control. In one example, a method for enhanced gain control is disclosed. Such A method may include receiving a wireless signal at a first radio, the wireless signal being received on a first frequency band and including at least a header and a payload, performing a first gain control operation based at least in part on information in the header of the wireless signal, determining that a second radio is to initiate a transmission on a second frequency band coinciding with the first frequency band before reception of the wireless signal is complete, wherein the second radio is co-located with the first radio, performing a second gain control operation based at least in part on an expected interference associated with the transmission from the second radio, and adjusting one or more gain levels for reception of the wireless signal based on the second gain control operation.

In another example, a wireless device is disclosed. Such a wireless device may include a first radio, one or more processors, and a memory. The memory may store instructions that, when executed by the one or more processors, cause the wireless device to receive a wireless signal at the first co-located radio, the wireless signal being received on a first frequency band and including at least a header and a payload, perform a first gain control operation based at least in part on information in the header of the wireless signal, determine that a second radio is to initiate a transmission on a second frequency band coinciding with the first frequency band before reception of the wireless signal is complete, the second radio co-located with the first radio, perform a second gain control operation based at least in part on an expected interference associated with the transmission from the second radio, and adjust one or more gain levels for reception of the wireless signal based on the second gain control operation.

In another example, an apparatus for wireless communication is disclosed. The apparatus may include a first interface configured to obtain a wireless signal from a first radio, the wireless signal being received on a first frequency band and including at least a header and a payload, and a processing system. The processing system may be configured to perform a first gain control operation based at least in part on information in the header of the wireless signal, determine that a second radio is to initiate a transmission on a second frequency band coinciding with the first frequency band before reception of the wireless signal is complete, wherein the second radio is co-located with the first radio, perform a second gain control operation based at least in part on an expected interference associated with the transmission from the second radio, and adjust one or more gain levels for reception of the wireless signal based on the second gain control operation.

In another example, a wireless device is disclosed. The wireless device may include means for receiving a wireless signal at a first radio, the wireless signal being received on a first frequency band and including at least a header and a payload, means for performing a first gain control operation based at least in part on information in the header of the wireless signal, means for determining that a second radio is to initiate a transmission using a second frequency band coinciding with the first frequency band before reception of the wireless signal is complete, wherein the second radio is co-located with the first radio, means for performing a second gain control operation based at least in part on an expected interference associated with the transmission from the second radio, and means for adjusting one or more gain levels for reception of the wireless signal based on the second gain control operation.

### BRIEF DESCRIPTION OF THE DRAWINGS

The example implementations are illustrated by way of example and are not intended to be limited by the figures of the accompanying drawings, where:

FIG. 1 shows a block diagram of a wireless system within which the example embodiments may be implemented.

FIG. 2A shows a block diagram of two co-located radios, in accordance with some implementations.

FIG. 2B shows another block diagram of two co-located radios, in accordance with some implementations.

FIG. 3 shows an example packet which may be used with a conventional gain control operation.

FIG. 4 shows an example Wi-Fi packet which may be used with a conventional automatic gain control (AGC) operation.

FIG. 5 shows a block diagram of a wireless station (STA) in accordance with example implementations.

FIG. 6 shows a block diagram of an access point (AP) in accordance with example implementations.

FIG. 7 shows enhanced gain control operation that may be performed during reception of a packet, in accordance with some implementations.

FIG. 8 shows an enhanced AGC operation that may be performed during reception of a Wi-Fi packet, in accordance with some implementations.

FIG. 9 is an illustrative flow chart, showing an example operation for enhanced gain control, in accordance with some implementations.

Like reference numerals refer to corresponding parts throughout the drawing figures.

### DETAILED DESCRIPTION

The example implementations are described below in the context of WLAN systems for simplicity only. It is to be understood that the example implementations are equally applicable to other wireless networks (e.g., cellular networks, pico networks, femto networks, satellite networks), as well as for systems using signals of one or more wired standards or protocols (e.g., Ethernet and/or HomePlug/PLC standards). As used herein, the terms “WLAN” and “Wi-Fi®” may include communications governed by the IEEE 802.11 family of standards, Bluetooth, HiperLAN (a set of wireless standards, comparable to the IEEE 802.11 standards, used primarily in Europe), and other technologies having relatively short radio propagation range. Thus, the terms “WLAN” and “Wi-Fi” may be used interchangeably herein. In addition, although described below in terms of an infrastructure WLAN system including one or more APs and a number of STAs, the example implementations are equally applicable to other WLAN systems including, for example, multiple WLANs, peer-to-peer (or Independent Basic Service Set) systems, Wi-Fi Direct systems, and/or Hotspots. In addition, although described herein in terms of exchanging data frames between wireless devices, the example implementations may be applied to the exchange of any data unit, packet, and/or frame between wireless devices. Thus, the term “frame” may include any frame, packet, or data unit such as, for example, protocol data units (PDUs), MAC protocol data units (MPDUs), and physical layer convergence procedure protocol data units (PPDUs). The term “A-MPDU” may refer to aggregated MPDUs.

In the following description, numerous specific details are set forth such as examples of specific components, circuits, and processes to provide a thorough understanding of the present disclosure. The term “coupled” as used herein means connected directly to or connected through one or more intervening components or circuits. The term “associated AP” refers to an AP with which a given STA is associated (e.g., there is an established communication channel or link between the AP and the given STA). The term “non-associated AP” refers to an AP with which a given STA is not associated (e.g., there is not an established communication channel or link between the AP and the given STA, and thus the AP and the given STA may not yet exchange data frames). The term “associated STA” refers to a STA that is associated with a given AP, and the term “non-associated STA” refers to a STA that is not associated with the given AP.

Also, in the following description and for purposes of explanation, specific nomenclature is set forth to provide a thorough understanding of the example implementations. However, it will be apparent to one skilled in the art that these specific details may not be required to practice the example implementations. In other instances, well-known circuits and devices are shown in block diagram form to avoid obscuring the present disclosure. The example implementations are not to be construed as limited to specific examples described herein but rather to include within their scopes all implementations defined by the appended claims.

As discussed above, performance in a wireless device may be degraded when two co-located radios simultaneously communicate using coinciding frequency bands. For example, if a first radio is receiving data using a particular frequency band while a co-located second radio is transmitting using a coinciding frequency band, the resulting interference may degrade performance of the first radio, and the received data. Two radios may be said to “use coinciding frequency bands” when the ranges of frequencies used by the transmissions or receptions of the two radios are overlapping, coinciding, or otherwise sufficiently similar to cause interference. For example, wireless communications may use identified frequency bands, such as the 2.4 GHz industrial, scientific, and medical (ISM) band, or frequency ranges near such an identified frequency band. If two co-located radios both communicate using frequency bands near this 2.4 GHz ISM band, then transmissions from one radio may interfere with receptions at the other radio. Thus, the two co-located radios may be said to use coinciding frequency bands. In some example, Wi-Fi, Bluetooth, and LTE communications may use sufficiently similar frequency bands to cause interference among co-located radios. More specifically, Wi-Fi communications may use channels including a subset of the ISM band, such as channels selected from a frequency range including 2402-2472 MHz. Similarly, Bluetooth communications may also use portions of the 2.4 GHz ISM band, such as including channels selected between 2402-2480 MHz. Further, LTE communications may use frequency bands which are sufficiently adjacent to the 2.4 GHz ISM band to cause interference, such as bands including 2300-2400 MHz and 2496-2690 MHz. For purposes of this disclosure, such Wi-Fi, Bluetooth, and LTE signals may each be said to use “coinciding frequency bands.”

Many wireless systems use gain control operations to determine appropriate amplifier gain settings. For example, the amplifier gain settings may include settings for one or more radio frequency (RF) amplifiers, one or more baseband (BB) amplifiers, and so on. For example, the IEEE 802.11 standard defines an automatic gain control (AGC) operation that may be performed to select a best gain value for an RF amplifier during reception of a packet. Such conventional gain control operations may be based on one or more fields of a header of a received packet. For example, in an AGC operation, one or more short training fields (STFs) may be used for determining appropriate RF amplifier gain settings. However, such conventional gain control operations do not account for interference caused by a co-located second radio transmitting on the same or similar frequency band. For the purposes of this disclosure two radios may be called “co-located” when they are sufficiently proximate that transmissions from the second radio may cause interference with reception of signals at the first radio. Such co-located radios may be part of a common wireless device or may be incorporated within separate but sufficiently proximate wireless devices.

Aspects of the present disclosure may enable a first radio to adjust its gain settings to mitigate interference caused by transmissions from a second co-located radio. More specifically, the example implementations allow a first radio to adjust its gain settings for data received over a first frequency band upon determining that a co-located second radio is to transmit using the first frequency band. Thus, the gain settings for the first radio may be appropriately selected to mitigate interference from the second radio. These and other details of the example implementations, which provide one or more technical solutions to the aforementioned problems, are described in more detail below.

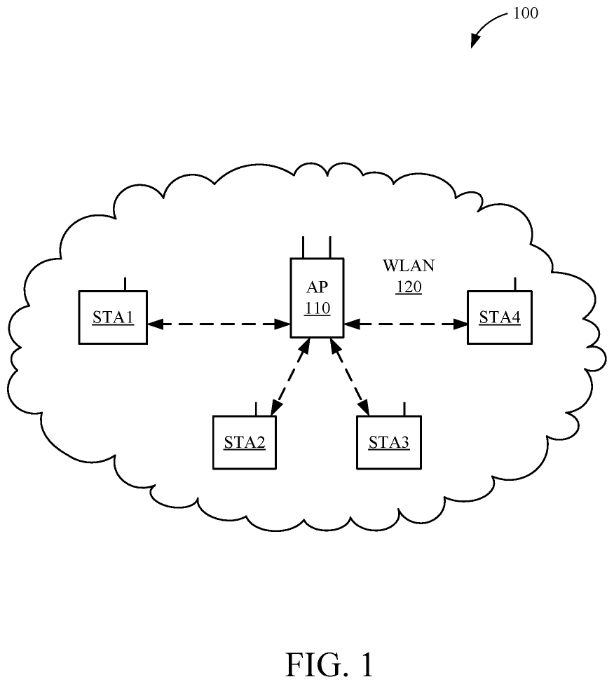

FIG. 1 is a block diagram of a wireless system 100 within which the example embodiments may be implemented. The wireless system 100 is shown to include four wireless stations STA1-STA4, a wireless access point (AP) 110, and a wireless local area network (WLAN) 120. The WLAN 120 may be formed by a plurality of Wi-Fi access points (APs) that may operate according to the IEEE 802.11 family of standards (or according to other suitable wireless protocols). Thus, although only one AP 110 is shown in FIG. 1 for simplicity, it is to be understood that WLAN 120 may be formed by any number of access points such as AP 110. The AP 110 is assigned a unique media access control (MAC) address that is programmed therein by, for example, the manufacturer of the access point. Similarly, each of stations STA1-STA4 is also assigned a unique MAC address. For some implementations, the wireless system 100 may correspond to a multiple-input multiple-output (MIMO) wireless network and may support single-user MIMO (SU-MIMO) and multi-user (MU-MIMO) communications. Further, although the WLAN 120 is depicted in FIG. 1 as an infrastructure BSS, for other example implementations, WLAN 120 may be an IBSS, an ad-hoc network, or a peer-to-peer (P2P) network (e.g., operating according to the Wi-Fi Direct protocols).

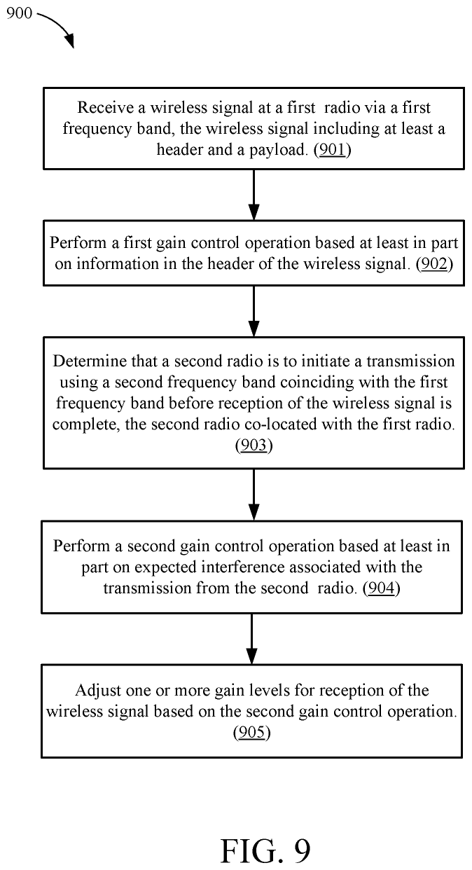

Each of stations STA1-STA4 may be any suitable Wi-Fi enabled wireless device including, for example, a cell phone, personal digital assistant (PDA), tablet device, laptop computer, or the like. Each of stations STA1-STA4 may also be referred to as a user equipment (UE), a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. For at least some implementations, each of stations STA1-STA4 may include one or more transceivers, one or more processing resources (e.g., processors and/or ASICs), one or more memory resources, and a power source (e.g., a battery). The memory resources may include a non-transitory computer-readable medium (e.g., one or more nonvolatile memory elements, such as EPROM, EEPROM, Flash memory, a hard drive, etc.) that stores instructions for performing operations described below with respect to FIG. 9.

The AP 110 may be any suitable device that allows one or more wireless devices to connect to a network (e.g., a local area network (LAN), wide area network (WAN), metropolitan area network (MAN), and/or the Internet) via AP 110 using Wi-Fi, Bluetooth, or any other suitable wireless communication standards. For at least one implementation, AP 110 may include one or more transceivers, one or more processing resources (e.g., processors and/or ASICs), one or more memory resources, and a power source. The memory resources may include a non-transitory computer-readable medium (e.g., one or more nonvolatile memory elements, such as EPROM, EEPROM, Flash memory, a hard drive, etc.) that stores instructions for performing operations described below with respect to FIG. 9.

For the stations STA1-STA4 and/or AP 110, the one or more transceivers may include Wi-Fi transceivers, Bluetooth transceivers, cellular transceivers, and/or other suitable radio frequency (RF) transceivers (not shown for simplicity) to transmit and receive wireless communication signals. Each transceiver may communicate with other wireless devices in distinct operating frequency bands and/or using distinct communication protocols. For example, the Wi-Fi transceiver may communicate within a 2.4 GHz frequency band, within a 5 GHz frequency band in accordance with the IEEE 802.11 specification, and/or within a 60 GHz frequency band. The cellular transceiver may communicate within various RF frequency bands in accordance with a 4G Long Term Evolution (LTE) protocol described by the 3rd Generation Partnership Project (3GPP) (e.g., between approximately 700 MHz and approximately 3.9 GHz) and/or in accordance with other cellular protocols (e.g., a Global System for Mobile (GSM) communications protocol). In other implementations, the transceivers included within each of the stations STA1-STA4 may be any technically feasible transceiver such as a ZigBee transceiver described by a specification from the ZigBee specification, a WiGig transceiver, and/or a HomePlug transceiver described a specification from the HomePlug Alliance.

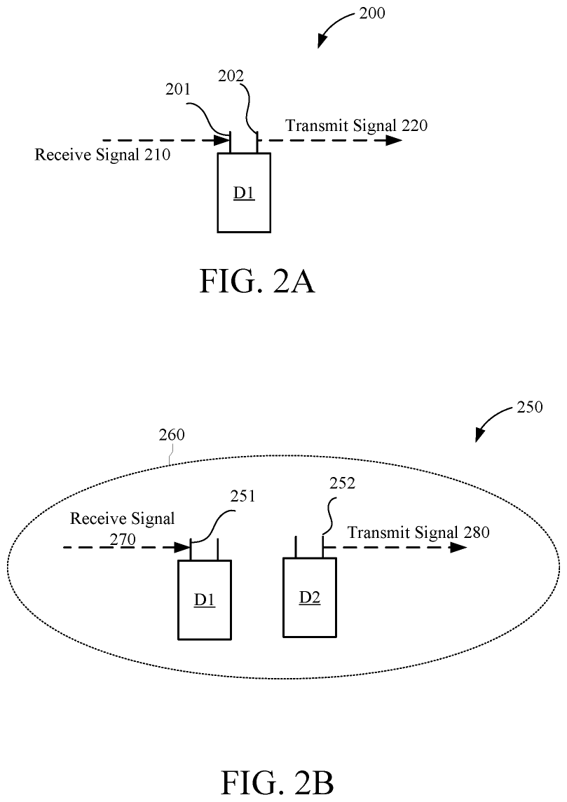

FIG. 2A shows a block diagram 200 of two co-located radios, in accordance with some implementations. With respect to FIG. 2A, a first wireless device D1 may include two co-located radios, a first radio 201, and a second radio 202. The first radio 201 may receive signal 210, while the second radio 202 sends a transmit signal 220. As discussed above, if the receive signal 210 is received using the same frequency band as the transmit signal 220 is sent, interference may result, impairing reception of the receive signal 210.

While FIG. 2A shows each of the two co-located radios within a common wireless device D1, in some implementations two co-located radios may be proximate without being in the same wireless device. FIG. 2B shows another block diagram 250 of two co-located radios, in accordance with some implementations. With respect to FIG. 2B, the first wireless device D1 may include a first radio 251, while a second wireless device D2 may include a second radio 252. The first radio 251 and the second radio 252 may be sufficiently proximate that transmissions from the second radio 252 may cause interference with reception of signals at the first radio 251. Such proximity is illustrated in FIG. 2B by the two radios being within a range of proximity 260. The first radio 251 may receive signal 270, while the second radio 252 sends a transmit signal 280. As discussed above, if the receive signal 270 is received using the same frequency band as the transmit signal 280 is sent, interference may result, impairing reception of the receive signal 270.

As discussed above, many wireless systems may perform gain control operations to determine appropriate amplifier gain settings, such as increased or reduced gain settings for one or more RF amplifiers, one or more baseband (BB) amplifiers, and so on. For example, a receiver may be configured to receive signals at a specified power level, such as signals having a specific received signal strength indication (RSSI) value. A gain control operation may set appropriate gain values for the RF amplifiers and BB amplifiers so that this specified power level is achieved at baseband. Such gain control operations may be performed based on a known portion of a received wireless signal. For example, wireless communication signals may include a packet containing at least a header and a payload. At least a portion of the header may be known and used for performing gain control operations.

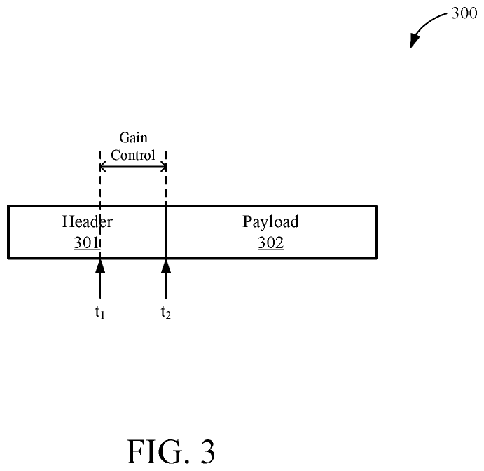

FIG. 3 shows an example packet 300 which may be used to perform a gain control operation. As shown in FIG. 3, the packet 300 may include a header 301 and a payload 302. At least a portion of the header 301 may include information known to the receiver. For example, the known portion of the header 301 may include one or more training fields. When the known portion of the header 301 is received—shown in FIG. 3 as time t₁, the receiver may perform a gain control operation. Example gain control operations may include estimating an average signal power of the wireless signal based on the known portion of the received packet 300. For example, the average signal power may be a radio frequency (RF) signal power or an intermediate frequency (IF) signal power. After estimating the average signal power, appropriate gain settings may be determined for the receiver, such as settings for one or more RF amplifiers or one or more BB amplifiers. Performing such a gain control operation while receiving the header 301 may allow for appropriate receiver gain settings to be adopted at the receiver before the payload 302 is received, at time t₂, thus avoiding potential loss of data while the gain control operation is performed (such as between times t₁ and t₂).

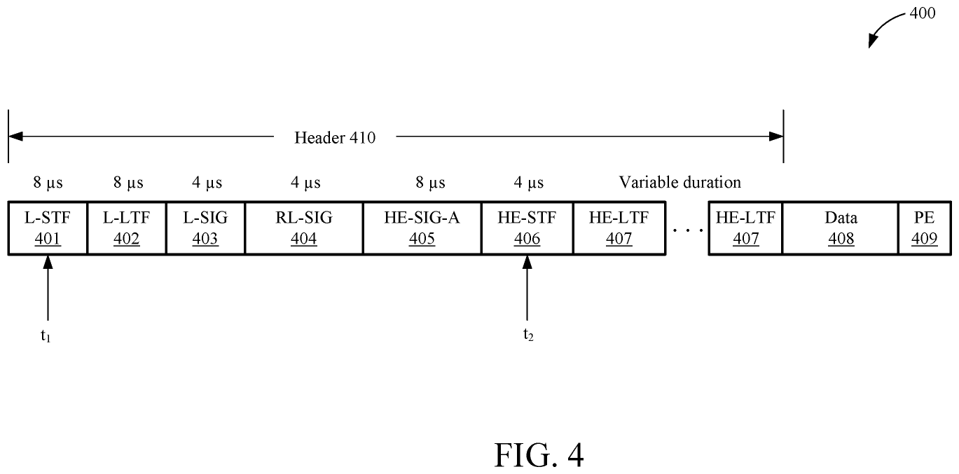

Automatic gain control (AGC) is an example operation which may be performed by a STA or an AP when receiving a wireless packet using an 802.11 (or “Wi-Fi”) protocol. FIG. 4 shows an example Wi-Fi packet 400 which may be used to perform automatic gain control (AGC). As shown in FIG. 4, the Wi-Fi packet 400 may include a legacy short training field (L-STF) 401, a legacy long training field (L-LTF) 402, a legacy signal field (L-SIG) 403, a repeated long signal field (RL-SIG) 404, a high-efficiency signal A field (HE-SIG-A) 405, a high-efficiency short training field (HE-STF) 406, a high-efficiency long training field (HE-LTF) 407, data (or payload) 408, and packet extension (PE) 409. A header 410 may include at least the L-STF 401, L-LTF 402, L-SIG 403, RL-SIG 404, HE-SIG-A 405, HE-STF 406, and HE-LTF 407. As described with respect to FIG. 3, the header 410 may also include known portions, such as training fields.

An AGC operation may be performed during reception of one or more short training fields, such as at times t₁ and t₂, during reception of L-STF 401 and HE-STF-406, respectively. This gain control operation may include estimating a signal power (such as an average signal power) of the wireless signal during the L-STF 401 or the HE-STF 406. For example, the signal power may be a radio frequency (RF) signal power or an intermediate frequency (IF) signal power. After estimating the signal power, appropriate gain settings may be determined for the receiver, such as settings for one or more RF amplifiers or one or more BB amplifiers. Performing such a gain control operation while receiving the header 410 may allow for appropriate receiver gain settings to be adopted at the receiver before the data 408 is received, thus avoiding potential loss of data while the gain control operation is performed.

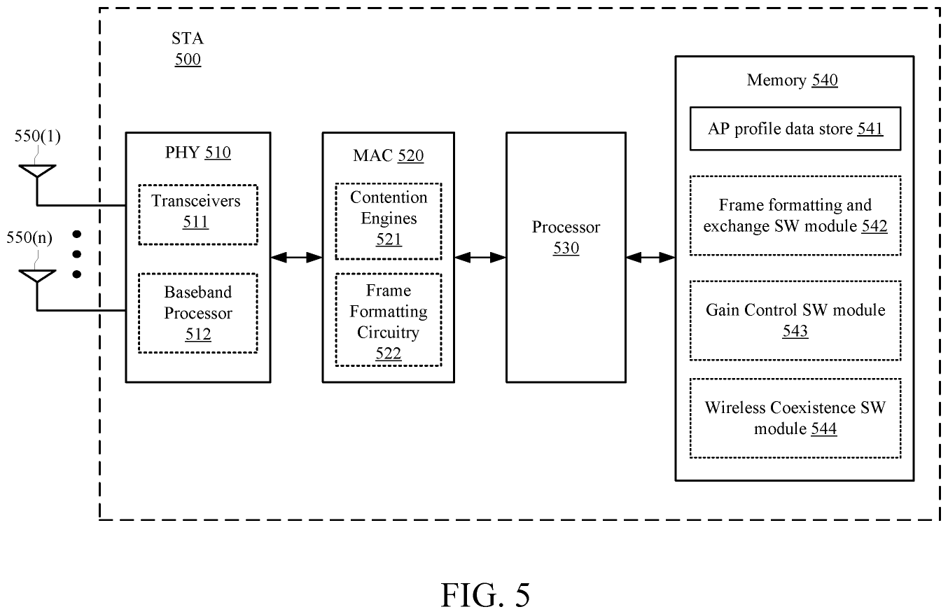

FIG. 5 shows an example STA 500 that may be one implementation of at least one of the stations STA1-STA4 of FIG. 1, or at least one of D1 or D2 of FIGS. 2A-2B. The STA 500 may include a PHY device 510 including at least a number of transceivers 511 and a baseband processor 512, may include a MAC 520 including at least a number of contention engines 521 and frame formatting circuitry 522, may include a processor 530, may include a memory 540, and may include a number of antennas 550(1)-550(n).

The transceivers 511 may be coupled to antennas 550(1)-550(n), either directly or through an antenna selection circuit (not shown for simplicity). The transceivers 511 may be used to transmit signals to and receive signals from AP 110 and/or other STAs (see also FIG. 1) and may be used to scan the surrounding environment to detect and identify nearby access points and/or other STAs (e.g., within wireless range of STA 500). Although not shown in FIG. 5 for simplicity, the transceivers 511 may include any number of transmit chains to process and transmit signals to other wireless devices via antennas 550(1)-550(n) and may include any number of receive chains to process signals received from antennas 550(1)-550(n). Thus, for example implementations, the STA 500 may be configured for MIMO operations. The MIMO operations may include single-user MIMO (SU-MIMO) operations and multi-user MIMO (MU-MIMO) operations.

The baseband processor 512 may be used to process signals received from processor 530 and/or memory 540 and to forward the processed signals to transceivers 511 for transmission via one or more of antennas 550(1)-550(n) and may be used to process signals received from one or more of antennas 550(1)-550(n) via transceivers 511 and to forward the processed signals to processor 530 and/or memory 540.

For purposes of discussion herein, MAC 520 is shown in FIG. 5 as being coupled between PHY device 510 and processor 530. For actual implementations, PHY device 510, MAC 520, processor 530, and/or memory 540 may be connected together using one or more buses (not shown for simplicity).

The contention engines 521 may contend for access to one more shared wireless mediums and may also store packets for transmission over the one more shared wireless mediums. The STA 500 may include one or more contention engines 521 for each of a plurality of different access categories. For other implementations, the contention engines 521 may be separate from MAC 520. For still other implementations, the contention engines 521 may be implemented as one or more software modules (e.g., stored in memory 540 or stored in memory provided within MAC 520) containing instructions that, when executed by processor 530, perform the functions of contention engines 521.

The frame formatting circuitry 522 may be used to create and/or format frames received from processor 530 and/or memory 540 (e.g., by adding MAC headers to PDUs provided by processor 530) and may be used to re-format frames received from PHY device 510 (e.g., by stripping MAC headers from frames received from PHY device 510).

Memory 540 may include an AP profile data store 541 that stores profile information for a plurality of APs. The profile information for a particular AP may include information including, for example, the AP's SSID, MAC address, channel information, RSSI values, goodput values, channel state information (CSI), supported data rates, connection history with the AP, a trustworthiness value of the AP (e.g., indicating a level of confidence about the AP's location, etc.), and any other suitable information pertaining to or describing the operation of the AP.

Memory 540 may also include a non-transitory computer-readable medium (e.g., one or more nonvolatile memory elements, such as EPROM, EEPROM, Flash memory, a hard drive, and so on) that may store at least the following software (SW) modules:
a frame formatting and exchange software module 542 to facilitate the creation and exchange of any suitable frames (e.g., data frames, action frames, and management frames) between STA 500 and other wireless devices;
a gain control SW module 543 to adjust one or more gain factors for wireless signals received by STA 500; and
a wireless coexistence SW module 544 to mitigate interference associated with transmissions of one or more co-located radios.
   Each software module includes instructions that, when executed by processor 530, cause STA 500 to perform the corresponding functions. The non-transitory computer-readable medium of memory 540 thus includes instructions for performing all or a portion of the STA-side operations depicted in FIG. 9.

Processor 530, which is shown in the example of FIG. 5 as coupled to PHY device 510, to MAC 520, and to memory 540, may be any suitable one or more processors capable of executing scripts or instructions of one or more software programs stored in STA 500 (e.g., within memory 540). For example, processor 530 may execute the frame formatting and exchange software module 542 to facilitate the creation and exchange of any suitable frames (e.g., data frames, action frames, and management frames) between STA 500 and other wireless devices. Processor 530 may also execute the gain control SW module 543 to adjust one or more gain factors for received wireless signals. Processor 530 may also execute the wireless coexistence SW module 544 to mitigate interference associated with transmissions of one or more co-located radios.

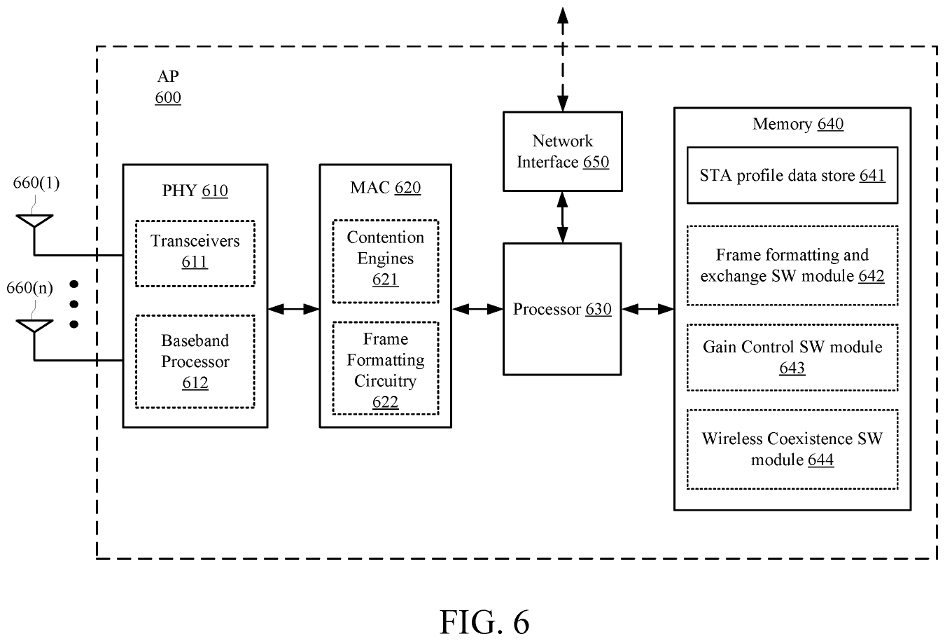

FIG. 6 shows an example AP 600 that may be one implementation of the AP 110 of FIG. 1, or one or more of wireless devices D1 or D2 of FIGS. 2A-2B. AP 600 may include a PHY device 610 including at least a number of transceivers 611 and a baseband processor 612, may include a MAC 620 including at least a number of contention engines 621 and frame formatting circuitry 622, may include a processor 630, may include a memory 640, may include a network interface 650, and may include a number of antennas 660(1)-660(n). The transceivers 611 may be coupled to antennas 660(1)-660(n), either directly or through an antenna selection circuit (not shown for simplicity). The transceivers 611 may be used to communicate wirelessly with one or more STAs, with one or more other APs, and/or with other suitable devices. Although not shown in FIG. 6 for simplicity, the transceivers 611 may include any number of transmit chains to process and transmit signals to other wireless devices via antennas 660(1)-660(n) and may include any number of receive chains to process signals received from antennas 660(1)-660(n). Thus, for example implementations, the AP 600 may be configured for MIMO operations including, for example, SU-MIMO operations and MU-MIMO operations.

The baseband processor 612 may be used to process signals received from processor 630 and/or memory 640 and to forward the processed signals to transceivers 611 for transmission via one or more of antennas 660(1)-660(n) and may be used to process signals received from one or more of antennas 660(1)-660(n) via transceivers 611 and to forward the processed signals to processor 630 and/or memory 640.

The network interface 650 may be used to communicate with a WLAN server (not shown for simplicity) either directly or via one or more intervening networks and to transmit signals.

Processor 630, which is coupled to PHY device 610, to MAC 620, to memory 640, and to network interface 650, may be any suitable one or more processors capable of executing scripts or instructions of one or more software programs stored in AP 600 (e.g., within memory 640). For purposes of discussion herein, MAC 620 is shown in FIG. 6 as being coupled between PHY device 610 and processor 630. For actual implementations, PHY device 610, MAC 620, processor 630, memory 640, and/or network interface 650 may be connected together using one or more buses (not shown for simplicity).

The contention engines 621 may contend for access to the shared wireless medium and may also store packets for transmission over the shared wireless medium. For some implementations, AP 600 may include one or more contention engines 621 for each of a plurality of different access categories. For other implementations, the contention engines 621 may be separate from MAC 620. For still other implementations, the contention engines 621 may be implemented as one or more software modules (e.g., stored in memory 640 or within memory provided within MAC 620) containing instructions that, when executed by processor 630, perform the functions of contention engines 621.

The frame formatting circuitry 622 may be used to create and/or format frames received from processor 630 and/or memory 640 (e.g., by adding MAC headers to PDUs provided by processor 630) and may be used to re-format frames received from PHY device 610 (e.g., by stripping MAC headers from frames received from PHY device 610).

Memory 640 may include a STA profile data store 641 that stores profile information for a plurality of STAs. The profile information for a particular STA may include information including, for example, its MAC address, previous AP-initiated channel sounding requests, supported data rates, connection history with AP 600, and any other suitable information pertaining to or describing the operation of the STA.

Memory 640 may also include a non-transitory computer-readable medium (e.g., one or more nonvolatile memory elements, such as EPROM, EEPROM, Flash memory, a hard drive, and so on) that may store at least the following software (SW) modules:
a frame formatting and exchange software module 642 to facilitate the creation and exchange of any suitable frames (e.g., data frames, action frames, and management frames) between AP 600 and other wireless devices;
a gain control SW module 643 to adjust one or more gain factors for wireless signals received by AP 600; and
a wireless coexistence SW module 644 to mitigate interference associated with transmissions of one or more co-located radios.
   Each software module includes instructions that, when executed by processor 630, cause AP 600 to perform the corresponding functions. The non-transitory computer-readable medium of memory 640 thus includes instructions for performing all or a portion of the AP-side operations depicted in FIG. 9.

Processor 630, which is shown in the example of FIG. 6 as coupled to PHY device 610 via MAC 620, to memory 640, and to network interface 650, may be any suitable one or more processors capable of executing scripts or instructions of one or more software programs stored in AP 600 (e.g., within memory 640). For example, processor 630 may execute the frame formatting and exchange software module 642 to facilitate the creation and exchange of any suitable frames (e.g., data frames, action frames, and management frames) between AP 600 and other wireless devices. Processor 630 may also execute the gain control SW module 643 to adjust one or more gain factors for wireless signals received by AP 600. Processor 630 may also execute the wireless coexistence SW module 644 to mitigate interference associated with transmissions of one or more co-located radios.

As discussed above, performance in a wireless device may be degraded when two co-located radios simultaneously communicate using coinciding frequency bands. For example, if a first radio is receiving data using a frequency band while a second radio, co-located with the first radio, is transmitting using a coinciding frequency band, the resulting interference may degrade performance of the first radio, and the accuracy of the received data. Note that the first radio and the second radio may be reside within the same wireless device. Alternatively, the first radio and the second radio may be in separate devices but proximate enough for transmissions of the second radio to interfere with reception at the first radio. Accordingly, the example implementations allow a first radio to adjust its gain settings for data reception over a first frequency band in response to a determination that the co-located second radio is to transmit using a second frequency band coinciding with the first frequency band.

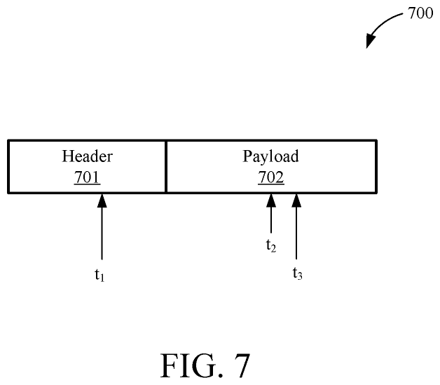

FIG. 7 shows an enhanced gain control operation that may be performed during reception of a packet 700, in accordance with some implementations. The packet 700 includes a header 701 and a payload 702. A receiver may perform a first gain control operation using the received portion of the header 701 at time t₁. The first gain control operation may determine and apply appropriate gain settings for receiving the packet 700 in the absence of interference (such as described above with respect to FIGS. 3 and 4). Aspects of the present disclosure recognize that such settings may be inappropriate in the presence of an interfering transmission, particularly an interfering transmission using a frequency band coinciding with the frequency band over which the packet 700 is received. For example, the interfering transmission may cause saturation of an RF amplifier, impairing accurate reception of the packet 700.

In some implementations, at a time t₂, the receiver may determine that a co-located second radio is to transmit on a frequency band coinciding with the frequency band over which the first radio is receiving the packet 700. For example, if the co-located second radio resides within the same wireless device as the first radio, this determination may be made using a coexistence manager, such as wireless coexistence software module 544 or 644 of respective FIG. 5 or 6.

At a time t₃, after determining that the co-located second radio is to transmit, the receiver may perform an enhanced gain control operation to adjust one or more gain settings based at least in part on the second radio's transmission. For example, such an enhanced gain control operation may include determining a gain change amount, determining when to apply the gain change, and recovering the receiver after applying the gain change.

Determining the gain change amount may include determining an estimated interference power at the first radio, such as at an antenna input of the first radio. The gain change amount may be based on a desired signal strength for the packet 700. For example, this desired signal strength may be a desired RSSI value, which may be estimated based on previously received portions of the packet 700. Thus, determining the gain change amount may include determining one or more gain settings for the first radio based on the estimated interference power and the desired signal strength. For example, the one or more gain settings may be stored in a gain table, and a lookup may be performed using the estimated interference power and the desired signal strength to determine the appropriate gain settings from the gain table. In one example, the appropriate gain settings may include reducing an RF gain to avoid low noise amplifier (LNA) saturation, while increasing BB amplification gains to maintain the desired RSSI value. In some other examples, there may be multiple BB and/or RF gain stages and determining the appropriate gain settings may include increasing or decreasing each of the gain stages to adjust the total RF and BB gain.

After determining the one or more gain settings, the one or more gain settings may be applied at an appropriate time. For example, if the estimated time of the transmission by the co-located second radio is known, then the one or more gain settings may be applied within a threshold period—such as 100 μs—before the second radio's transmission. Applying the gain settings within the threshold period of the second radio's transmission may result in corruption of some data in the received packet 700 but may allow more of the received packet 700 to be received using the new gain settings. In another example, the one or more gain settings may be applied during a known gap, such as a guard interval, in the received packet 700. This guard interval may be a guard interval before the second radio's transmission is to begin, such as a final guard interval before the second radio's transmission is to begin.

Note that after the gain settings have been applied, saturation of one or more amplifiers may still occur in the receiver path of the first radio. In accordance with some implementations, in response to determining that saturation has occurred after applying the one or more gain settings, an amplifier gain may be further reduced. For example, in response to detecting saturation of a BB amplifier or an analog to digital converter (ADC), the BB gain may be further reduced. Such reduction may impair reception of some of the data in the packet 700 but may improve reception of data transmitted later in the packet 700.

After applying the one or more gain settings, the receiver of the first radio may be recovered. Such recovery may include updating information such as phase tracking information, amplitude tracking information, and channel estimation information.

In one example implementation, the first radio may be receiving Wi-Fi data via a 2.4 GHz frequency band, when a co-located second radio begins transmitting according to a Bluetooth protocol. Because the Bluetooth protocol and the Wi-Fi protocol both transmit and receive information using the 2.4 GHz frequency band, the Bluetooth transmission may interfere with the reception of Wi-Fi data via the first radio. Accordingly, some implementations may allow for a Wi-Fi radio to update one or more gain settings in response to determining that such a co-located Bluetooth radio is to begin a transmission.

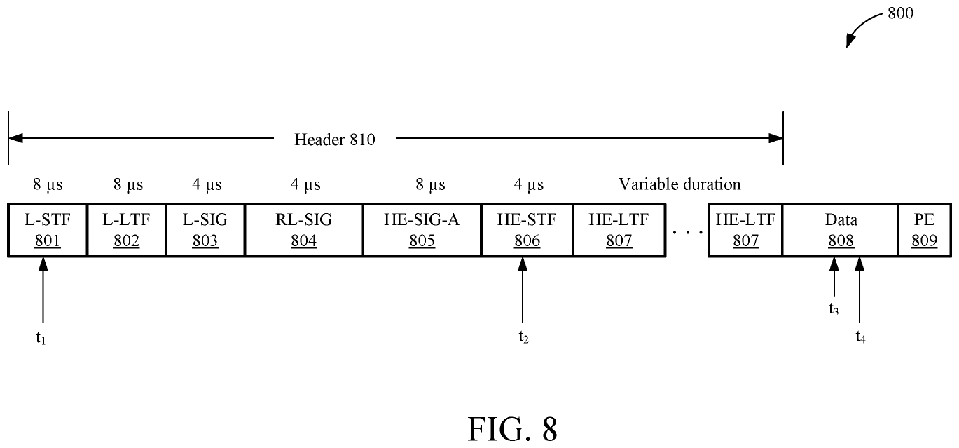

FIG. 8 shows an enhanced AGC operation that may be performed during reception of a Wi-Fi packet 800, in accordance with some implementations. The packet 800 may include a legacy short training field (L-STF) 801, a legacy long training field (L-LTF) 802, a legacy signal field (L-SIG) 803, a repeated long signal field (RL-SIG) 804, a high-efficiency signal A field (HE-SIG-A) 805, a high-efficiency short training field (HE-STF) 806, a high-efficiency long training field (HE-LTF) 807, data (or payload) 808, and packet extension (PE) 809. A header 810 may include at least the L-STF 801, L-LTF 802, L-SIG 803, RL-SIG 804, HE-SIG-A 805, HE-STF 806, and HE-LTF 807. Note that packet 800 is shown in accordance with the 802.11ax protocol for simplicity only, and that other implementations may support enhanced gain control operations for other versions of the 802.11 protocol, including without limitation 802.11a/b/g/n and so on.

As described with respect to FIG. 4, a receiver may perform an AGC operation, such as at times t₁ and t₂, during reception of L-STF 801 and HE-STF-806, respectively. Because Wi-Fi packet 800 may be received over a 2.4 GHz frequency band, nearby wireless transmissions over coinciding frequency bands (such as Bluetooth) may interfere with reception of packet 800. For example, at a time t₃, the receiver may determine that a co-located second radio is to transmit using Bluetooth. If the co-located second radio and the first radio reside within the same wireless device, then this determination may include a coexistence manager determining that the second radio will begin the Bluetooth transmission in the near future. For example, the coexistence manager may make such a determination by executing wireless coexistence SW module 544 or 644 of respective FIGS. 5-6. If the co-located second radio is not a part of the same wireless device as the first radio, then this determination may include the coexistence manager detecting that the second radio has already begun the Bluetooth transmission.

After determining that the co-located second radio is to transmit using Bluetooth, an enhanced gain control operation may be performed at time t4, to adjust one or more gain settings based on the co-located second radio's transmission. As described with respect to FIG. 7, such an enhanced gain control operation may include determining a gain change amount, determining when to apply the gain change, and recovering the receiver after applying the gain change.

Determining the gain change amount may include determining an estimated interference power at the first radio, such as determining an estimated Bluetooth interference power at an antenna input of the first radio. Further, if the co-located second radio and the first radio are part of the same wireless device, the estimated Bluetooth interference power may be based on a known transmission power of the Bluetooth transmission, which may be determined by a coexistence manager of the wireless device. The gain change amount may further be based on a desired signal strength for the packet 800. For example, this desired signal strength may be a desired Wi-Fi RSSI value, which may be estimated based on previously received portions of the packet 800. Alternatively, the desired Wi-Fi RSSI value may be determined based on one or more beacons received from an associated AP. Thus, determining the gain change amount may include determining one or more gain settings for the first radio based on the estimated Bluetooth interference power and the desired signal strength. The one or more gain settings may be stored in a gain table, and a lookup may be performed using the estimated Bluetooth interference power and the desired signal strength to determine the appropriate gain settings from the gain table. For example, the appropriate gain settings may include reducing an RF gain, for example to avoid low noise amplifier (LNA) saturation, while increasing BB amplification gains to maintain the desired Wi-Fi RSSI value. In some other examples, there may be multiple BB and/or RF gain stages and determining the appropriate gain settings may include increasing or decreasing each of the gain stages to adjust the total RF and BB gain.

After determining the one or more gain settings, the receiver may apply the one or more gain settings at an appropriate time. For example, if the estimated time of the Bluetooth transmission by the co-located second radio is known, then the one or more gain settings may be applied within a threshold period—such as 100 μs—before the Bluetooth transmission. Applying the gain settings within the threshold period of the Bluetooth transmission may result in loss of a number of OFDM symbols, and potentially corruption of one or more MPDUs in the received packet 800—while the gain settings are applied, and the receiver is recovered—but may allow more of the received packet 800 to be received using the new gain settings. In another example, the one or more gain settings may be applied during a known gap, such as a guard interval, in the received packet 800. For example 802.11ax may include a guard interval of 3.2 μs. In some implementations applying the gain settings during such a guard interval may avoid loss of any OFDM symbols if the gain settings are applied and the receiver recovers before additional data is received. This guard interval may be a guard interval before the second radio's transmission is to begin, such as a final guard interval before the second radio's transmission is to begin.

Note that after the gain settings have been applied, saturation of one or more amplifiers may still occur in the receiver path of the first radio. In accordance with some implementations, in response to determining that saturation has occurred after applying the one or more gain settings, an amplifier gain may be further reduced. For example, in response to detecting saturation of a BB amplifier or an analog to digital converter (ADC), the BB gain may be further reduced. Such reduction may result in loss of one or more OFDM symbols of the packet 800 but may improve reception of later-transmitted MPDUs in the packet 800.

After applying the one or more gain settings, the receiver of the first radio may be recovered. Such recovery may include updating information such as phase tracking information, amplitude tracking information, and channel estimation information. For example, the first radio may use a pilot tracking feature to track phase changes and to update channel estimation information after the one or more gain settings have been applied. In addition, a calibration of the first radio may be used to estimate phase changes associated with corresponding gain changes. The amplitude tracking information may be based on the one or more gain settings—more particularly, comparing the previous gain settings to the adjusted gain settings indicates the change in amplitude.

FIG. 9 is an illustrative flow chart of an example operation 900 for enhanced gain control, in accordance with some implementations. The operation 900 may be performed by any suitable first wireless device including at least a first radio, such as any of STAs 1-4 or AP 110 of FIG. 1, D1 of FIGS. 2A-2b, STA 500 of FIG. 5, AP 600 of FIG. 6, and so on. In some implementations this first wireless device may also include a co-located second radio, while in other implementations the co-located second radio may be a part of a second wireless device.

With respect to FIG. 9, the first wireless device may receive a wireless signal at a first radio via a first frequency band, the wireless signal including at least a header and a payload (901). In some implementations the wireless signal may be a packet compatible with an 802.11 protocol, and the first frequency band may be a 2.4 GHZ frequency band. The first wireless device may then perform a first gain control operation based on one or more fields of the header of the wireless signal (902). In some implementations the first gain control operation may be an automatic gain control (AGC) operation. The one or more fields of the header may include one or more known fields of the header, such as one or more training fields of the header. Further, the one or more training fields may include one or more short training fields (STFs) of the header.

The first wireless device may determine that a second radio is to initiate a transmission using a second frequency band coinciding with the first frequency band before reception of the wireless signal is completed, where the second radio is co-located with the first radio (903). In some implementations the second radio may also be a part of the first wireless device, while in some other implementations the second radio may be a part of a second wireless device. In some implementations the transmission using the second frequency band may be a Bluetooth transmission using the 2.4 GHz frequency band.

The first wireless device may then perform a second gain control operation based at least in part on expected interference associated with the transmission from the second co-located radio (904). In some implementations, the second gain control operation may be based at least in part on an estimated interference power received at the first radio. In some implementations the second gain control operation may also be based at least in part on a desired signal strength for the wireless signal received at the first radio, such as a desired RSSI for the wireless signal received at the first radio. In some implementations the second gain control operation may include determining a reduced radio frequency gain to avoid saturation of a low-noise amplifier of the first radio, and to determine a correspondingly increased baseband gain to maintain an overall receiver gain for the first radio and a desired signal strength for the wireless signal.

The first wireless device may then adjust one or more gain levels for reception of the wireless signal based on the second gain control operation (905). In some implementations the one or more gain levels may be adjusted in response to determining that the second radio's transmission is to begin within a threshold duration, such as 100 μs. In some implementations the one or more gain levels may be adjusted during a guard interval (GI) of the wireless signal. In some implementations, the adjusted one or more gain levels may include the determined reduced radio frequency gain and correspondingly increased baseband gain. In some implementations, after adjusting the one or more gain levels, the first wireless device may detect a saturation at baseband of the first radio, and in response reduce a baseband gain of the first radio. In some implementations, the first wireless device may also update, based on the adjusted one or more gain levels, phase tracking, amplitude tracking, and channel estimation for the first radio.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The methods, sequences or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

In the foregoing specification, the example implementations have been described with reference to specific example implementations thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

What is claimed is:

1. A method for wireless gain control, comprising:
receiving a wireless signal at a first radio, the wireless signal being received on a first frequency band and comprising at least a header and a payload;
performing a first gain control operation based at least in part on information in the header of the wireless signal;
determining that a second radio is to initiate a transmission on a second frequency band coinciding with the first frequency band before reception of the wireless signal is complete, wherein the second radio is co-located with the first radio;
performing a second gain control operation based at least in part on an expected interference associated with the transmission from the second radio; and
adjusting one or more gain levels for reception of the wireless signal based on the second gain control operation.

2. The method of claim 1, wherein the wireless signal is a packet compatible with an IEEE 802.11 protocol, and the transmission of the second radio is a Bluetooth transmission.

3. The method of claim 1, wherein the wireless signal is a packet compatible with an IEEE 802.11 protocol, and the transmission of the second radio is an LTE transmission.

4. The method of claim 1, wherein the second gain control operation is based at least in part on an estimated interference power received at the first radio.

5. The method of claim 1, wherein the second gain control operation is based at least in part on a desired signal strength for the wireless signal received at the first radio.

6. The method of claim 1, wherein the second gain control operation is to reduce a radio frequency gain to avoid saturation of a low-noise amplifier (LNA) of the first radio, and to increase baseband gain to maintain an overall receiver gain for the first radio and a desired signal strength for the wireless signal.

7. The method of claim 1, further comprising detecting, after adjusting the one or more gain levels, a baseband saturation at the first radio, and reducing a baseband gain of the first radio.

8. The method of claim 1, wherein the first radio and the second radio reside within a single wireless device.

9. The method of claim 1, wherein the one or more gain levels are adjusted in response to determining that the transmission by the second radio is to begin within a threshold duration.

10. The method of claim 1, wherein the one or more gain levels are adjusted during a guard interval (GI) of the wireless signal.

11. The method of claim 1, further comprising updating, based on the adjusted one or more gain levels, phase tracking, amplitude tracking, and channel estimation for the first radio.

12. A wireless device, comprising:
a first radio;
one or more processors; and
a memory storing instructions that, when executed by the one or more processors, cause the wireless device to:
receive a wireless signal at a first radio, the wireless signal being received on a first frequency band and comprising at least a header and a payload;
perform a first gain control operation based at least in part on information in the header of the wireless signal;
determine that a second radio is to initiate a transmission on a second frequency band coinciding with the first frequency band before reception of the wireless signal is complete, the second radio co-located with the first radio;
perform a second gain control operation based at least in part on an expected interference associated with the transmission from the second radio; and
adjust one or more gain levels for reception of the wireless signal based on the second gain control operation.

13. The wireless device of claim 12, wherein the wireless signal is a packet compatible with an IEEE 802.11 protocol, and the transmission of the second radio is a Bluetooth transmission.

14. The wireless device of claim 12, wherein the wireless signal is a packet compatible with an IEEE 802.11 protocol, and the transmission of the second radio is an LTE transmission.

15. The wireless device of claim 12, wherein the second gain control operation is based at least in part on an estimated interference power received at the first radio.

16. The wireless device of claim 12, wherein the second gain control operation is to reduce a radio frequency gain to avoid saturation of a low-noise amplifier (LNA) of the first radio, and to increase baseband gain to maintain an overall receiver gain for the first radio and a desired signal strength for the wireless signal.

17. The wireless device of claim 12, wherein execution of the instructions further causes the wireless device to detect, after adjusting the one or more gain levels, a baseband saturation at the first radio, and reducing a baseband gain of the first radio.

18. The wireless device of claim 12, wherein the wireless device further comprises the second radio.

19. The wireless device of claim 12, wherein the one or more gain levels are adjusted in response to determining that the transmission by the second radio is to begin within a threshold duration.

20. The wireless device of claim 12, wherein the one or more gain levels are adjusted during a guard interval (GI) of the wireless signal.

21. The wireless device of claim 12, wherein execution of the instructions further causes the wireless device to update, based on the adjusted one or more gain levels, phase tracking, amplitude tracking, and channel estimation for the first radio.

22. An apparatus for wireless communication, comprising:
a first interface configured to obtain a wireless signal from a first radio, the wireless signal being received on a first frequency band and comprising at least a header and a payload; and
a processing system configured to:
perform a first gain control operation based at least in part on information in the header of the wireless signal;
determine that a second radio is to initiate a transmission on a second frequency band coinciding with the first frequency band before reception of the wireless signal is complete, wherein the second radio is co-located with the first radio;
perform a second gain control operation based at least in part on an expected interference associated with the transmission from the second radio; and
adjust one or more gain levels for reception of the wireless signal based on the second gain control operation.

23. The apparatus of claim 22, wherein the wireless signal is a packet compatible with an IEEE 802.11 protocol, and the transmission of the second radio is a Bluetooth transmission.

24. The apparatus of claim 22, wherein the wireless signal is a packet compatible with an IEEE 802.11 protocol, and the transmission of the second radio is an LTE transmission.

25. The apparatus of claim 22, wherein the second gain control operation is based at least in part on a desired signal strength for the wireless signal received at the first radio.

26. The apparatus of claim 22, wherein the second gain control operation is to reduce a radio frequency gain to avoid saturation of a low-noise amplifier (LNA) of the first radio, and to increase baseband gain to maintain an overall receiver gain for the first radio and a desired signal strength for the wireless signal.

27. The apparatus of claim 22, wherein the one or more gain levels are adjusted in response to determining that the transmission by the second radio is to begin within a threshold duration.

28. The apparatus of claim 22, wherein the one or more gain levels are adjusted during a guard interval (GI) of the wireless signal.

29. The apparatus of claim 22, further comprising a receiver configured to receive the wireless signal, wherein the apparatus is configured as a wireless node.

30. A wireless device, comprising:
means for receiving a wireless signal at a first radio, the wireless signal being received on a first frequency band and comprising at least a header and a payload;
means for performing a first gain control operation based at least in part on information in the header of the wireless signal;
means for determining that a second radio is to initiate a transmission using a second frequency band coinciding with the first frequency band before reception of the wireless signal is complete, wherein the second radio is co-located with the first radio;
means for performing a second gain control operation based at least in part on an expected interference associated with the transmission from the second radio; and
means for adjusting one or more gain levels for reception of the wireless signal based on the second gain control operation.
